(19) United States
(12) Patent Application Publication
(10) Pub. No.: US 2019/0128194 A1
(43) Pub. Date: May 2, 2019

(54) NITROUS SAFETY CONTROL SYSTEM AND METHOD OF USE

(71) Applicant: Kyle Robitzsch, Mesquite, TX (US)

(72) Inventor: Kyle Robitzsch, Mesquite, TX (US)

(21) Appl. No.: 16/177,324

(22) Filed: Oct. 31, 2018

Related U.S. Application Data
(60) Provisional application No. 62/579,316, filed on Oct. 31, 2017.

(51) Int. Cl. F02D 19/12; B60W 10/30; F02B 13/10; F02B 43/12; F02M 25/10

(52) U.S. Cl. CPC F02D 19/12; B60W 10/30; F02M 25/10; F02B 43/12; F02B 13/10

(57) ABSTRACT

A nitrous safety control system includes a first computing device in communication with a throttle position sensor, an RPM sensor, and a fuel pressure sensor; a second computing device in communication with a nitrous bottle pressure sensor and a bottle heater; a third computing device having a display; and a CAN BUS network to facilitate communication between the first, second, and third computing devices; the system activates a nitrous circuit based on data received from the first and second computing devices.

### BACKGROUND

### 1. Field of the Invention

The present invention relates generally to nitrous oxide injection systems, and more specifically, to a nitrous oxide safety control system for injecting nitrous oxides into vehicular engines.

### 2. Description of Related Art

Nitrous oxide injection systems are well known for use in engines and provide effective means to increase the oxygen in an engine, thus increasing the amount of fuel the engine can take, and ultimately increasing the engine's power.

One of the problems commonly associated with conventional nitrous oxide systems is safety. For example, conventional systems do not include proper monitoring and reactive techniques to prevent dangerous and damaging conditions from arising. For example, conventional nitrous systems do not properly monitor fuel pressure, which can result in the use of nitrous oxide in unfavorable conditions. The use of nitrous oxide in such unfavorable conditions can lead to engine damage or failure, resulting in dangerous conditions.

Accordingly, although great strides have been made in the area of nitrous oxide injection systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified schematic of a first segment of a nitrous safety control system in accordance with a preferred embodiment of the present application;

FIG. 2 is a simplified schematic of a second segment of the nitrous safety control system;

FIG. 3 is a simplified schematic of a third segment of the nitrous safety control system; and

FIG. 4 is a flowchart illustrating the preferred method of use of the system.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional nitrous safety control systems. Specifically, the system of the present invention provides a means to effectively monitor fuel pressure and thereby prevent damage and dangerous conditions from arising. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

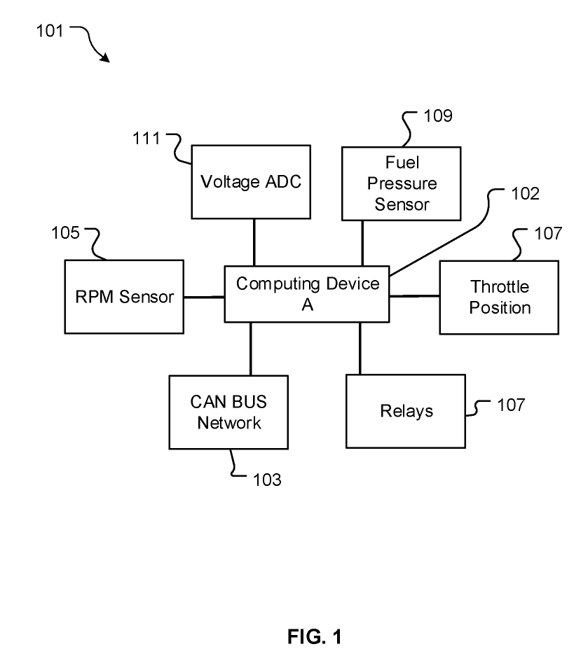

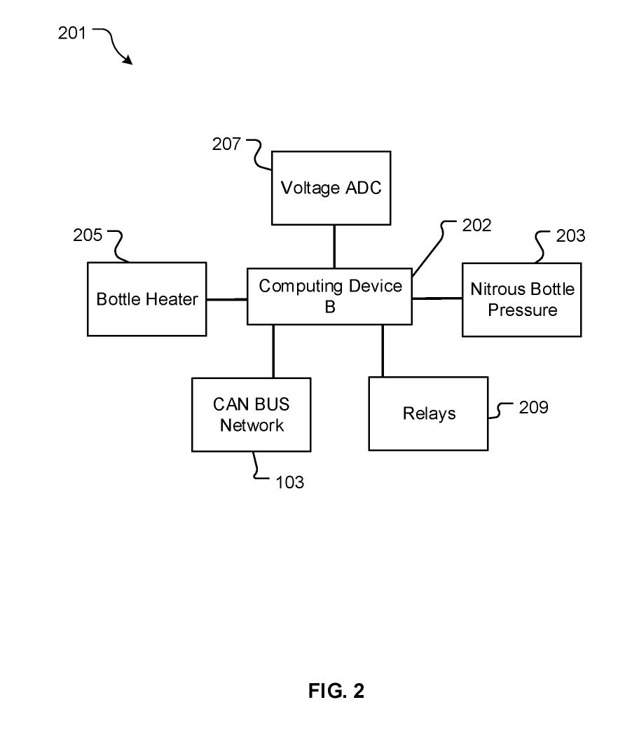

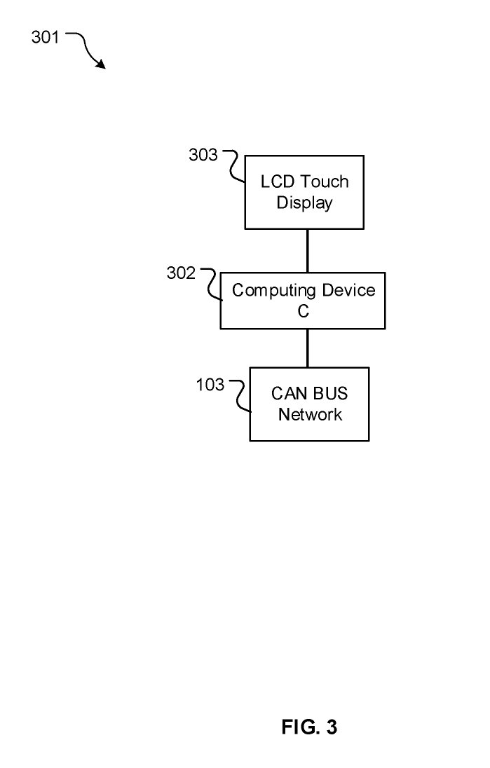

Referring now to the drawings wherein like reference characters identify corresponding or similar elements throughout the several views, FIGS. 1-3 depict simplified schematics of three segments 101, 201, 301 of a nitrous oxide safety system to be included and/or installed within a vehicle in accordance with a preferred embodiment of the present application. It will be appreciated that system overcomes one or more of the above-listed problems commonly associated with conventional nitrous oxide injection systems.

In the contemplated embodiment, each segment 101, 201, 301 includes a computing device 102, 202, 302 all configured with a communication module to provide for connection to a CAN BUS network 103, thereby allowing for the various components to communicate with one another. The computing devices are configured to receive readings, process data, and implement commands based on the various other components of the nitrous safety control system.

It should be appreciated that the various computing devices can be a single individual unit, or alternatively can be a plurality of units, such as a server, a microprocessor, a database, or any other units capable of receiving and analyzing data.

In the contemplated embodiment, computing device A is in communication with an RPM sensor 105 configured to measure RPM and determine a position of the crankshaft to measure speed of a vehicle; a throttle position sensor 107 configured to provide throttle position readings to computing device A. Both of these inputs are necessary for determining when nitrous is to be used by the vehicle system. Further, a fuel pressure sensor 109 is configured to measure fuel pressure, such as a drop in fuel pressure. It should be appreciated that this sensor can be an aftermarket sensor installed directly into the vehicle system, or alternatively, it is contemplated that computing device A 102 can be programmed to directly communicate with a fuel rail pressure sensor already installed within the vehicle system. It should be appreciated that computing device A 102 will receive small changes within fuel pressure and be programed to make modifications to various components as determined by the fuel pressure.

The first segment further includes a voltage analog to digital converter 111 and one or more electrical relays 113.

The second segment 201 includes a nitrous bottle pressure sensor 203 configured to read and determine the pressure associated with the nitrous bottle of the vehicle system. It should be appreciated that various sensors could be developed to attach to and be in communication with various nitrous bottles. One contemplated embodiment includes a ⅛ NPT fitting that is configured to fit on a plurality of nitrous bottles. In the present invention, the nitrous pressure sensor 203 transmits the nitrous bottle reading to computing device B 202 thereby allowing for data analysis and appropriate reactive functions based on the reading. Segment 201 further includes connection to a nitrous bottle heater 205.

The second segment further includes a voltage analog to digital converter 207 and one or more electrical relays 209.

The third segment 301 includes computing device C 302 with a display 303, such as an LCD touch screen, configured to receive user commands. For example, the user can open and close the nitrous bottle via the display. This segment can be mounted within the vehicle, or otherwise provided to the user for commanding the system. Further, the display can provide a visual representation of various data, including fuel pressure, nitrous pressure, and other data.

In the preferred embodiment, the system receives a fuel pressure sensor reading, a nitrous bottle pressure reading, and other various data from other components (described above). The system is thereby configured to cut off the nitrous circuit of the vehicle based on the received readings and data. In the preferred embodiment, this command is made upon fuel pressure dropping below a pre-determined value. It is contemplated that a window switch, either newly installed, or previously incorporated, can be controlled to activate and deactivate nitrous.

It should be appreciated that one of the unique features believed characteristic of the present invention is the combination of elements into one system that improves the safety and functionality of a nitrous system. In addition, the present invention provides an improved monitoring system for the various components.

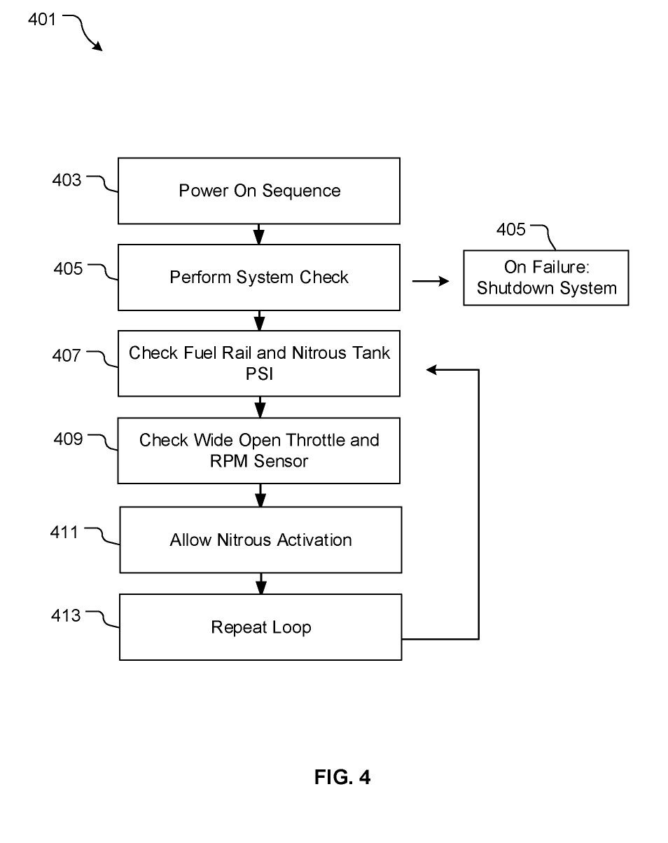

In FIG. 4, a flowchart 401 depicts the method of use of the system. During use, the various computing devices and segments of the system are activated, wherein the system performs a system check, as shown with boxes 403, 405. If there is a failure, then the system shutdown, as shown with box 406. Once the system has activated, the various computing devices check fuel rail and nitrous tank PSI, and check wide open throttle and the RPM sensor, as shown with boxes 407, 409. Based on the fuel pressure reaching a predetermined value, the system allows nitrous activation, as shown with box 411. This loop repeats as necessary, as shown with box 413.

It should be appreciated that the precise monitoring of fuel pressure, in combination with the various other components configured to shut of the nitrous circuit, allows for improved safety and management of a nitrous system within a vehicle. This system aids in preventing damage from fuel pressure dropping.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A nitrous safety control system for a vehicle, the system comprising:
a first computing device in communication with a throttle position sensor, an RPM sensor, and a fuel pressure sensor;
a second computing device in communication with a nitrous bottle pressure sensor and a bottle heater;
a third computing device having a display; and
a CAN BUS network configured to facilitate communication between the first, second, and third computing devices;
wherein the system activates a nitrous circuit based on data received from the first and second computing devices.

2. The system of claim 1, wherein the first computing device further comprises:
a voltage analog to digital converter; and
one or more electrical relays.

3. The system of claim 1, wherein the display is an LCD touch display.

4. The system of claim 1, wherein the second computing device is in communication with a bottle heater.

5. A method of controlling a nitrous circuit of a vehicle, the method comprising:
connecting a first computing device to a throttle position sensor, an RPM sensor, and a fuel pressure sensor within the vehicle;
connecting a second computing device to a nitrous bottle pressure sensor;
providing a third computing device with a display for user manipulation;
connecting the first, second, and third computing devices through a CAN BUS network;
receiving data from the fuel pressure sensor, the throttle position sensor, the RPM sensor, and the nitrous bottle pressure sensor; and
controlling a nitrous circuit based the data received.
